(19) United States
(12) Patent Application Publication
(10) Pub. No.: US 2024/0238747 A1
(43) Pub. Date: Jul. 18, 2024

(54) IMMERSION TYPE ROTATING PACKED BED REACTOR AND APPLICATION THEREOF

(71) Applicant: BEIJING UNIVERSITY OF CHEMICAL TECHNOLOGY, Beijing (CN)

(72) Inventors: Jianfeng CHEN, Beijing (CN); Guangwen CHU, Beijing (CN); Liangliang ZHANG, Beijing (CN); Baochang SUN, Beijing (CN); Haikui ZOU, Beijing (CN); Yong LUO, Beijing (CN)

(21) Appl. No.: 18/574,374

(22) PCT Filed: Jul. 1, 2022
(86) PCT No.: PCT/CN2022/103252

§ 371 Date: Dec. 27, 2023

(30) Foreign Application Priority Data
Jul. 2, 2021 (CN) 202110752496.8

(51) Int. Cl. B01J 8/10; B01J 8/08

(52) U.S. Cl. CPC B01J 8/10; B01J 8/087; B01J 2208/00132; B01J 2208/00867

(57) ABSTRACT

The present invention discloses an immersion type rotating packed-bed reactor and an application thereof. A rotor filler is immersed in materials in the reactor; under the driving of the rotation of a rotor, the materials in the reactor form a loop; and when passing through the filler, the materials are fully sheared and dispersed into fluid micro-elements, so that the mass transfer rate and the reaction rate are increased. A feeding assembly simultaneously introduces materials of different phases to an inner edge of the rotor, a retaining ring and a baffle function to break a vortex, and a heat exchange assembly can maintain a system in a suitable temperature range. The present invention is suitable for heterogeneous systems such as a gas-liquid system and a liquid-liquid system. Compared with a conventional rotating packed bed, the material contact time is long, so that the reaction is more complete.

### TECHNICAL FIELD

The present invention relates to the technical field of reactors, and more particularly, to an immersion type rotating packed-bed reactor and an application thereof.

### BACKGROUND

A heterogeneous reaction includes a gas-liquid reaction, a gas-liquid-solid reaction, an immiscible two-liquid-phase reaction and the like, and the diffusion of a reactant to a phase interface and the area of the phase interface directly affect the mass transfer rate and the reaction rate of different phases. Process intensification has a significant effect on the heterogeneous reaction, the shearing force can fully mix and disperse different phases, and the scale of a dispersion unit directly affects the interface area size and the reaction rate.

The rotating packed bed is a typical process intensification device, and is capable of shearing a liquid phase at a high speed to form a fast renewed droplet, liquid film and liquid silk with a large specific surface area, and the mass transfer rate and the reaction rate are greatly enhanced. The reactant has a short residence time in the bed, different phases have a short contact time and a short reaction time, and two phases are enabled to fully react by means of external continuous loop.

The removal of the heat released in the reaction process is key for keeping the temperature in the reactor in a suitable range, and there are now two solutions for internal heat exchange of the rotating packed bed, i.e., heat exchange by means of external circulation liquid and heat exchange by adding a third-phase solvent; and the external circulation heat exchange requires continuous external circulation, and the process of adding the third-phase solvent is cumbersome, and the effect is limited.

The characteristics of the rotating packed bed determine that it is suitable for a rapid reaction, how to increase the contact time of reactants in the rotating packed bed, and how to design a simple and efficient heat exchange solution for the rotating packed bed are important directions for the expansion of the rotating packed bed application.

### SUMMARY

The technical problem to be solved by the present invention is to provide an immersion type rotating packed-bed reactor and an application thereof, which intensify the heterogeneous reaction process, increase the contact time of reactants, and can also simply and efficiently remove the reaction heat.

In order to solve the above problem, the present invention employs a technical solution as follows:

An immersion type rotating packed-bed reactor. A rotor filler is immersed in materials in the reactor; and when a rotor is driven by a motor to rotate, the materials move from an inner edge of the rotor to an outer edge of the rotor under the action of centrifugal force, and the materials are fully sheared when passing through the filler and are dispersed into fluid micro-elements. Under the driving of the rotation of the rotor, the materials in the reactor forms a loop, so that the materials in the reactor are uniformly mixed;

Preferably, the materials are introduced from the inner edge of the rotor, move towards the outer edge of the rotor, pass through a retaining ring and then lead to an upper portion of the reactor under the action of a guide plate, are subjected to a pressure difference when reaching the upper end of a feeding assembly, and lead to the inner edge of the rotor through the feeding assembly to form a loop.

The immersion type rotating packed-bed reactor is provided with the feeding assembly such that reactants of different phases can simultaneously lead to the rotor;

Preferably, the feeding assembly is a casing pipe structure, an inner pipe is in communication with a feeding port of the reactor, and the top end of an outer pipe is located below the liquid level in the reactor;

Preferably, a vortex breaking structure is arranged between casing pipes of the feeding assembly, and the vortex breaking structure is preferably a baffle;

Preferably, the baffle is located between the casing pipes formed by two feeding pipes, and the lower end thereof extends to a bottom plane of the rotor;

The immersion type rotating packed-bed reactor is provided with a heat exchange assembly for keeping the materials in the reactor in a suitable operating temperature range;

Preferably, the heat exchange assembly is a tubular structure, reaction materials pass through the tube, and a heat exchange medium is introduced outside the tube.

The immersion type rotating packed-bed reactor is provided with a guide plate for guiding the materials at an outlet of the retaining ring to the upper portion of the reactor, so as to form a loop in the reactor;

Preferably, the form of the guide plate comprises a straight plate and a curved plate with different curvature;

Preferably, the guide plate may be multi-layer distributed and arranged step by step in the radial direction, and the step by step flow guide amount is increased.

The immersion type rotating packed-bed reactor is provided with a retaining ring which forms a barrier between the rotor and a main body region of the reactor;

Preferably, a side wall of the retaining ring is provided with openings along the circumference, and the materials thrown out of the outer edge of the rotor lead to the main body region of the reactor via the openings;

Preferably, the lower half portion of the side wall of the retaining ring is an upright column structure, and the materials inside and outside the retaining ring can form a loop through a gap of the upright column.

Any range described in the present invention includes end values, any value between the end values, and any sub-range formed by the end values or any value between the end values.

Unless otherwise specified, all the raw materials in the present invention may be commercially available, and the device used in the present invention may be a conventional device in the art or be performed by referring to the prior art.

The present invention has the following beneficial effects:

(1) According to the immersion type rotating packed-bed reactor of the present invention, a discrete phase and a dispersed phase lead to the rotor filler in a cocurrent flow manner, and are fully mixed and dispersed by the high-speed shearing of the filler, and in comparison with separately dispersing a gas phase or a liquid phase and then mixing with another phase, the coalescence can be reduced, and the mixing effect is better.

(2) The immersion type rotating packed-bed reactor of the present invention is reasonably provided with the guide plate, under the action of the guide plate, the liquid in the bed forms a loop, the dispersed phase is continuously dispersed into the looping liquid, and the dispersion uniformity of the two phases is perfect.

(3) According to the immersion type rotating packed-bed reactor of the present invention, during a gas-liquid reaction, the gas is dispersed into the liquid in the form of microbubbles, and the obtained microbubbles have a small diameter, a large specific surface area, and a high internal air pressure, facilitating the sufficient reaction of the gas and liquid, and enhancing the reaction conversion rate.

(4) According to the immersion type rotating packed-bed reactor of the present invention, the baffle is arranged between the two feeding pipes to achieve the effect of breaking a vortex, thus preventing the liquid in the feeding pipes from being driven by a rotating shaft to generate the vortex, saving the shaft power, and in the meantime preliminarily mixing the two phases before entering the filler.

### BRIEF DESCRIPTION OF DRAWINGS

FIG. 1 is an overall structural schematic diagram of an immersion type rotating packed-bed reactor of the present invention.

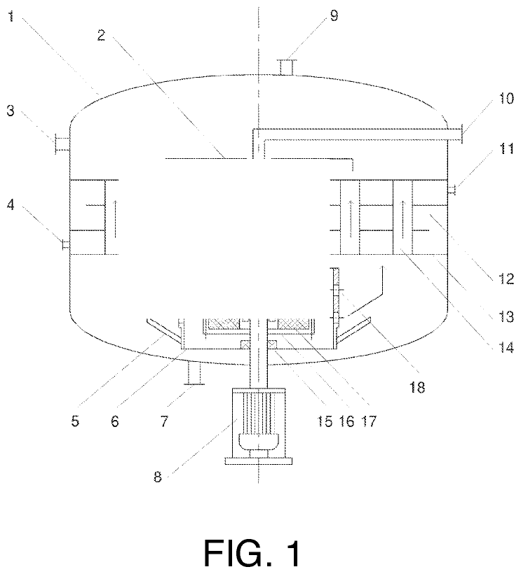

FIG. 2 is a three-view diagram of an immersion type rotating packed-bed reactor of the present invention.

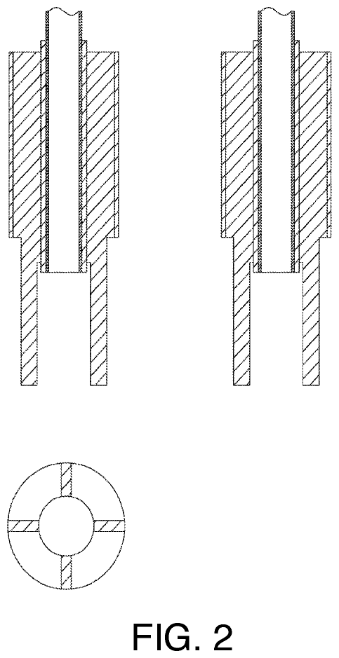

Wherein: 1—housing, 2—outer pipe of feeding assembly, 3—feeding port, 4—heat exchange medium inlet, 5—guide plate, 6—retaining ring, 7—discharge port, 8—motor, 9—discharge port, 10—inner pipe of feeding assembly, 11—heat exchange medium outlet, 12—baffle plate, 13—tube plate, 14—heat exchange tube, 15—seal, 16—baffle, 17—filler, and 18—opening.

### DETAILED DESCRIPTION OF THE EMBODIMENTS

In order to describe the present invention more clearly, the present invention is further described below in conjunction with preferred embodiments and accompanying drawings. In the drawings, the like reference signs are used for representing the like parts. It should be understood by those skilled in the art that the following detailed description is illustrative rather than restrictive, and should not limit the scope of protection of the present invention.

Various sectional drawings according to the embodiments of the present invention are shown in the accompanying drawings. These drawings are not drawn to scale, with certain details enlarged and certain details omitted for purposes of clarity. Various regions and shapes of layers as well as relative sizes and positional relations among them shown in the figures are merely illustrative. In practice, there may be deviations due to manufacturing tolerances or technical limitations, and those skilled in the art may additionally design regions/layers with different shapes, sizes and relative positions according to actual needs.

An immersion type rotating packed-bed reactor, in which a rotor filler is immersed in materials in the reactor; and when a rotor is driven by a motor to rotate, the materials move from an inner edge of the rotor to an outer edge of the rotor under the action of centrifugal force, and the materials are fully sheared when passing through the filler and are dispersed into fluid micro-elements. Under the driving of the rotation of the rotor, the materials in the reactor forms a loop, such that the materials in the reactor are uniformly mixed;

Preferably, the materials are introduced from the inner edge of the rotor, move towards the outer edge of the rotor, pass through a retaining ring and then lead to an upper portion of the reactor under the action of a guide plate, the materials are subjected to a pressure difference when reaching the upper end of a feeding assembly, and lead to the inner edge of the rotor through the feeding assembly to form a loop.

The immersion type rotating packed-bed reactor is provided with the feeding assembly such that reactants of different phases can simultaneously lead to the rotor;

Preferably, the feeding assembly is a casing pipe structure, an inner pipe is in communication with a feeding port of the reactor, and the top end of an outer pipe is located below the liquid level in the reactor;

Preferably, a vortex breaking structure is arranged between casing pipes of the feeding assembly, and the vortex breaking structure is preferably a baffle;

Preferably, the baffle is located between the casing pipes formed by two feeding pipes, and the lower end thereof extends to the bottom plane of the rotor;

The immersion type rotating packed-bed reactor is provided with a heat exchange assembly for keeping the materials in the reactor in a suitable operating temperature range;

Preferably, the heat exchange assembly is a tubular structure, the reaction materials pass through the tube, and the exterior of the tube is in communication with a heat exchange medium.

The immersion type rotating packed-bed reactor is provided with a guide plate for guiding the materials at the outlets of the retaining ring to the upper portion of the reactor, so as to form a loop in the reactor;

Preferably, the form of the guide plate comprises a straight plate and a curved plate with different curvature;

Preferably, the guide plate may be multi-layer distributed and arranged step by step in the radial direction, and the step by step flow guide amount is increased.

The immersion type rotating packed-bed reactor is provided with a retaining ring which forms a barrier between the rotor and the main body region of the reactor;

Preferably, the side wall of the retaining ring is provided with openings along its circumference, and the materials thrown out of the outer edge of the rotor lead to the main body region of the reactor through the openings;

Preferably, the lower half portion of the side wall of the retaining ring is an upright column structure, and the materials inside and outside the retaining ring can form a loop through a gap of the upright column.

In some implementations of the present invention, the filler shape comprises an annular hollow cylinder and a multi-segment distributed annular cylinder; and the filler type comprises a porous medium filler and a wire mesh filler.

In some implementations of the present invention, for a system with an unobvious thermal effect, no heat exchange assembly is provided, the extension length of the guide plate is correspondingly increased, the cross-sectional area of a loop channel when not passing through heat exchange tubes is larger than that when passing through the heat exchange tubes, and the loop flow formed by the rotation of the rotor is large.

In some implementations of the present invention, the guide plate is multi-layer distributed and is arranged step by step in the radial direction, the step by step flow guide amount is increased and is proportional to the corresponding annular cross-sectional area, and the overflow form is from the center to the outside, so that the overall looping materials are guided to the upper portion of the reactor.

In some implementations of the present invention, the openings of the retaining ring are altered, the openings are connected to guide pipes, the guide pipes extend to the upper portion of the reactor, and compared with only arranging openings, after connected to the guide pipes, the materials flowing out of the retaining ring are more concentrated and more directly lead into the heat exchange assembly tubes for timely heat exchange, so that the heat exchange efficiency is higher.

In some implementations of the present invention, the feeding assembly is modified, for a gas-liquid heterogeneous reaction system, a gas is introduced into an inner pipe of the feeding assembly, the inner pipe of the feeding assembly extends and is provided with dispersion conduits along its circumference such that the gas can lead evenly and more closely to the inner edge of the filler along the circumference, thus avoiding the gas overflowing from an outer pipe of the feeding assembly before reaching the inner edge of the filler.

### Embodiment 1

The immersion type rotating packed-bed reactor of the present invention is used to perform the reaction of p-nitrophenol in ozone-degraded water, the concentration of gaseous ozone is 20 mg L⁻¹, the gaseous ozone is introduced from a feeding port, leads to the filler through the inner pipe of the feeding assembly; and the concentration of p-nitrophenol in the solution in the reactor is 100 mg L⁻¹, the rotation speed of the rotating packed bed ranges from 500 r/min to 6,000 r/min, the removal rate of p-nitrophenol can reach about 95% through sufficient reaction, ozone mass transfer is enhanced, and the amount of dissolved ozone is increased.

### Embodiment 2

The immersion type rotating packed-bed reactor in the present invention is used to perform the reaction of acid red B in ozone-oxidized water, and a catalyst iron-cobalt bimetallic oxide is attached to the surface of the porous filler by using a chemical means. The solution is added to the reactor, a cooling medium pump and a motor switch are turned on, ozone is introduced after the loop is stable, and the rotation speed ranges from 500 r/min to 6,000 r/min. The result shows that the removal rate of the acid red B rises as the rotation speed increases, the increase amplitude of the removal rate is remarkable after the increase of the rotation speed at the early stage, but the increase amplitude is not remarkable at the late stage. Under an optimal operating condition, the removal rate of the acid red B can reach about 98%, and the ozone utilization rate is about 96%.

### Embodiment 3

The immersion type rotating packed-bed reactor in the present invention is used to perform a liquid-liquid heterogeneous reaction of fatty acid methyl ester epoxidation, hydrogen peroxide is used as an oxygen source, formic acid is used as an oxygen carrier, the mass fraction of the hydrogen peroxide used is 50%, the mass fraction of the formic acid is 86%, the molar ratio of the double bond concentration to the hydrogen peroxide concentration is 1: 1.5, the molar ratio of the double bond concentration to the formic acid concentration is 1: 0.23, the reaction temperature is 70° C., the volume fraction of the aqueous phase is about 0.3, the rotation speed of the rotating packed bed ranges from 500 r/min to 6,000 r/min, and the epoxy value and iodine value of the obtained epoxidized fatty acid methyl ester are 6 and 1.9, respectively.

Apparently, the above-described embodiments of the present invention are merely examples to clearly describe the present invention, but not limitation to the implementations. To those of ordinary skill in the art, various other modifications or variations can further be made on the basis of the above description. All implementations cannot be exhaustive herein. Obvious modifications or variations extended from the technical solution of the present invention are still in the protection scope of the present invention.

1. An immersion type rotating packed-bed reactor, wherein a rotor filler is immersed in materials in the reactor; when a rotor is driven by a motor to rotate, the materials move from an inner edge of the rotor to an outer edge of the rotor under the action of centrifugal force, when passing through the filler, the materials are fully sheared and dispersed into fluid micro-elements.

2. An immersion type rotating packed-bed reactor, wherein under a driving of the rotation of a rotor, materials in the reactor form a loop so that the materials in the reactor are uniformly mixed, and
the materials are introduced from an inner edge of the rotor, move towards an outer edge of the rotor, pass through a retaining ring and then lead to an upper portion of the reactor under the action of a guide plate, the materials are subjected to a pressure difference when reaching an upper end of a feeding assembly, and lead to the inner edge of the rotor through the feeding assembly to form a loop.

3. An immersion type rotating packed-bed reactor, wherein materials lead to an inner edge of a rotor through a feeding assembly, the feeding assembly enables reactants of different phases to simultaneously lead to a filler;
the feeding assembly is a casing pipe structure, an inner pipe is in communication with a feeding port of the reactor, and a top end of an outer pipe is located below the liquid level in the reactor;
a vortex breaking structure is arranged between casing pipes of the feeding assembly; and
the baffle is located between the casing pipes formed by two feeding pipes, and the lower end thereof extends to a bottom plane of the rotor.

4. An immersion type rotating packed-bed reactor, wherein a heat exchange assembly is arranged for keeping materials in the reactor in a suitable operating temperature range; and
the heat exchange assembly is a tubular structure, reaction materials pass through tubes, and an exterior of the tubes is in communication with a heat exchange medium.

5. An immersion type rotating packed-bed reactor, wherein a guide plate is arranged for guiding materials at an outlet of a retaining ring to an upper portion of the reactor, thereby facilitating formation of a loop in the reactor;
the guide plate comprises a straight plate and a curved plate of different curvature; and
the guide plate is multi-layer distributed and arranged step by step in the radial direction, and a step by step flow guide amount is increased.

6. An immersion type rotating packed-bed reactor, wherein a retaining ring is arranged to form a barrier between a rotor and a main body region of the reactor;
a side wall of the retaining ring is provided with openings along its circumference, and materials thrown out of an outer edge of the rotor lead to the main body region of the reactor through the openings; and
a lower half portion of the side wall of the retaining ring is an upright column structure, and the materials inside and outside the retaining ring are formable into a loop through a gap of the upright column.

7. The immersion type rotating packed-bed reactor of claim 3, wherein the vortex breaking structure is a baffle.
